(19) United States
(12) Patent Application Publication
(10) Pub. No.: US 2024/0346429 A1
(43) Pub. Date: Oct. 17, 2024

(54) SHIPPING MOBILITY MANAGEMENT SYSTEM AND METHOD

(71) Applicants: Hyundai Motor Company, Seoul (KR); Kia Corporation, Seoul (KR)

(72) Inventors: Sunjoo Moon, Suwon-si (KR); Wonseok Choi, Seongnam-si (KR); Hyejun Park, Seoul (KR)

(21) Appl. No.: 18/635,415

(22) Filed: Apr. 15, 2024

(30) Foreign Application Priority Data
Apr. 14, 2023 (KR) 10-2023-0049406
Jul. 31, 2023 (KR) 10-2023-0099592

(51) Int. Cl. G06Q 10/0833

(52) U.S. Cl. CPC G06Q 10/0833

(57) ABSTRACT

A shipping mobility management system may include a mobile-object information database that contains basic information and 3D modeling of each moving object with respect to a plurality of moving objects, a 3D drawing DB that stores a 3D map which is a 3D representation of a map representing a place where the plurality of moving objects is located, a management server that finds a moving object matched with moving object information received from the outside in the mobile-object information DB, and records the moving object location received from the outside in association with the found moving object information in the mobile-object information DB, and a 3D map generating unit that generates a 3D map by combining the 3D modeling of the found moving object with the 3D map.

### CROSS-REFERENCE TO RELATED APPLICATIONS

This application claims priority to and the benefit of Korean Patent Application No. 10-2023-0049406 filed in the Korean Intellectual Property Office on Apr. 14, 2023, and Korean Patent Application No. 10-2023-0099592 filed in the Korean Intellectual Property Office on Jul. 31, 2023, the entire contents of which for both are incorporated herein by reference.

### TECHNICAL FIELD

The present disclosure relates to a shipping mobility management system and method.

### BACKGROUND

Workers move moving objects scheduled to be shipped, by themselves. For example, when vehicles that are a kind of moving object have been produced at an automobile production factory and are scheduled to be shipped, workers drive the corresponding vehicles by themselves to move them. When vehicles accumulate in a place for storing vehicles to be shipped (hereinafter, referred to as a storage for vehicles to be shipped), it is difficult for workers to find the locations of vehicles that they should move, in real time, and the amount of time required to find the locations of the vehicles occur. Further, workers remember the locations of the moved vehicles and input them into a system themselves, which may cause a difference between the actual location of a vehicle and the location information input to the system.

### SUMMARY

The present disclosure relates to a shipping mobility management system and method. Some embodiments of the present disclosure can provide a shipping mobility management system and method capable of providing the locations of moving objects on a three-dimensional (3D) map.

A shipping mobility management system according to an embodiment of the present disclosure may include a mobile-object information DB that stores basic information and 3D modeling of each moving object with respect to a plurality of moving objects, a 3D drawing DB that stores a 3D map that is a 3D representation of a map representing a place where the plurality of moving objects is located, a management server that finds a moving object matched with moving object information received from the outside in the mobile-object information DB, and records the moving object location received from the outside in association with the found moving object information in the mobile-object information DB, and a 3D map generating unit that generates a 3D map by combining the 3D modeling of the found moving object with the 3D map.

When an error occurs between a parking site where the moving object should be stored among a plurality of parking sites and the vehicle location received from the outside, the 3D map generating unit may map the received vehicle location to the nearest parking site among the plurality of parking sites.

When another vehicle is already located at the nearest parking site, the 3D map generating unit may notify it to the management server, and the management server may identify the moving object using cameras, find the actual location of the moving object, and provide the actual location to the 3D map generating unit.

The management server may receive the moving object location from a worker terminal of a worker who moves the moving object and/or of the moving object.

A shipping mobility management method according to an embodiment of the present disclosure may include a step of allowing a management server to receive a management number of a moving object required to be moved and a location lookup request from a worker terminal, and read location information on the moving object corresponding to the management number from a vehicle information DB, a step of allowing the management server to generate a movement route on the basis of a worker location based on GPS information received from the worker terminal and the location information on the moving object, a step of allowing a 3D map generating unit to generate a 3D guide map by combining a movement route guide line along the movement route generated by the management server with a 3D map, and a step of allowing the management server to transmit the 3D guide map to the worker terminal.

The shipping mobility management method may further include a step of allowing the 3D map generating unit to generate the 3D guide map by combining the location of the worker and the location and information of the moving object required to be moved with the 3D map.

An embodiment of the present disclosure can provide the shipping mobility management system and method capable of providing the locations of moving objects on a 3D map.

### BRIEF DESCRIPTION OF THE DRAWINGS

FIG. 1 is a drawing illustrating a system for managing vehicles to be shipped according to an example embodiment of the present disclosure.

FIG. 2 is a drawing in which vehicles are displayed on a 3D map implemented according to an example embodiment of the present disclosure.

FIG. 3 is a flow chart illustrating a movement route display method according to an example embodiment of the present disclosure.

### DETAILED DESCRIPTION OF ILLUSTRATIVE EMBODIMENTS

Items that are movable (hereinafter, referred to as moving objects) may be moved to and stored at specific locations in a specific place that has a predetermined area and is for storing moving objects (hereinafter, referred to as a storage), or may be stopped at certain locations in the storage and be moved to other locations or taken out of the storage. Workers who carry out moving tasks as mentioned above can provide worker locations, the current locations of moving objects, the locations to which moving objects are to be moved such as the locations at which moving objects are to be stored, etc., through a 3D map to worker terminals. Moving objects may include vehicles, shuttles, mobile robots, personal mobility devices, etc., for example

As example embodiments, vehicles will be described as moving objects, and a place for storing vehicles to be shipped, i.e., a storage for vehicles to be shipped will be described as a storage. In the present disclosure, as an example of a shipping mobility management system for providing a 3D map to worker terminals, a system for managing vehicles to be shipped will be described. Any or all of the example embodiments to be mentioned in the following description can be applied to shipping mobility management systems in the same manner.

In an embodiment of the present disclosure, a system for managing vehicles to be shipped may provide vehicle information registration and current state confirmation with respect to vehicles in the storage for vehicles to be shipped. The system for managing vehicles to be shipped may configure a parking space in a 3D map on a map. The system for managing vehicles to be shipped may generate and use 3D modeling data to recognize the appearances and colors of vehicles. When parking a vehicle, the system for managing vehicles to be shipped may receive the location of the vehicle from a worker terminal, and/or receive GPS information immediately before the operation of the vehicle stops, from the vehicle. When the vehicle does not have a GPS, a worker may transmit the location of the vehicle to the system for managing vehicles to be shipped, through an application installed in a worker terminal. The system for managing vehicles to be shipped may display the received vehicle location on a 3D map.

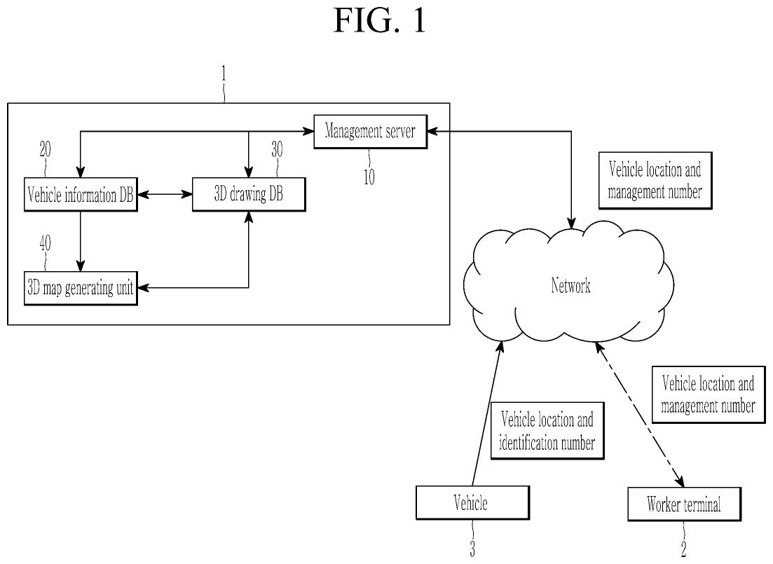

FIG. 1 is a drawing illustrating a system for managing vehicles to be shipped according to an example embodiment of the present disclosure.

A system 1 for managing vehicles to be shipped can include a management server 10, a vehicle information database (DB) 20, a 3D drawing DB 30, and a 3D map generating unit 40, any combination of or all of which may be in plural or may include plural components thereof.

The management server 10 may transmit and receive information to and from a worker terminal 2 through a network. For example, the worker terminal 2 may transmit vehicle locations and management numbers to the management server 10. In FIG. 1, one worker terminal 2 is shown; however, a plurality of worker terminals corresponding to a plurality of workers who carry out tasks at a storage for vehicles to be shipped may transmit and receive information to and from the management server 10 through the network. In the worker terminal 2, an application capable of processing information that is provided by the management server 10 and processing information that is acquired by the worker terminal 2 may be installed for managing vehicles to be shipped. The worker terminal 2 may include a wireless communication device capable of transmitting and receiving information through the network.

The management server 10 may receive vehicle locations from vehicles capable of transmitting and receiving information through the network. For example, a vehicle 3 may include a GPS and a wireless communication device. When the vehicle 3 is moved by the worker, the vehicle may determine GPS information that is acquired from the GPS of the vehicle 3 before the vehicle is stopped, i.e., when the vehicle gear is shifted into the P position, as the vehicle location, and transmit it to the management server 10. At this time, the vehicle 3 may transmit a number capable of identifying the vehicle 3 (hereinafter, referred to as an identification number) to the management server 10 along with the vehicle location. Information on the vehicle location may be provided not only from the vehicle 3 but also or alternatively through the worker terminal 2. The worker terminal 2 may include a GPS, and may determine location information acquired from the GPS, as the vehicle location. The worker terminal 2 may transmit the management number of the vehicle to the management server 10 along with the vehicle location. The management number of the vehicle can be a number capable of identifying the vehicle, and may be directly input to the worker terminal 2 by a worker or may be acquired by QR scanning, barcode scanning, etc. For example, a vehicle barcode attached to the C-pillar of the vehicle may be the management number of the vehicle.

The management server 10 may find a vehicle that matches the vehicle information of the vehicle 3 (e.g., using the management number or the identification number) received from the worker terminal 2 and/or the vehicle, among vehicles stored in the vehicle information DB 20, and record the vehicle location in the vehicle information DB 20 in association with the corresponding vehicle. The vehicle location may be a location based on the GPS information of the worker terminal 2 or the GPS information of the vehicle 3.

In association with a plurality of vehicles located in the storage for vehicles to be shipped, the vehicle information DB 20 may store basic information on the vehicles (e.g., vehicle names, management numbers, production dates, buyers, etc.), 3D modeling of the vehicles, and so on, for example.

The 3D drawing DB 30 may store a 3D drawing that can be a 3D representation of a map representing the storage for vehicles to be shipped (hereinafter, referred to as a 3D map). The 3D drawing DB 30 may store maps of various storages for storing some items in the form of a 3D drawing, as well as maps of storages for storing vehicles to be shipped.

The 3D map generating unit 40 may determine a location corresponding to the vehicle 3 on a 3D map representing the storage for vehicles to be shipped, on the basis of the vehicle location received from the corresponding vehicle or the worker terminal 2, and derive 3D modeling of the corresponding vehicle stored in the vehicle information DB 20, and generate a 3D map by mapping the 3D modeling of the corresponding vehicle to the location of the corresponding vehicle determined on the 3D map. The management server 10 may transmit the generated 3D map to the worker terminal 2.

The 3D map generating unit 40 may map the vehicle location received from the vehicle 3 and/or the worker terminal 2 to the nearest storage location when an error occurs between the location where the vehicle should be stored and the vehicle location received from the vehicle 3 and/or the worker terminal 2. The storage for vehicles to be shipped can have a plurality of unit areas (hereinafter, referred to as parking sites) divided so that a plurality of vehicles can be located. The 3D map can contain location information on each of the plurality of parking sites. When the vehicle location received from the vehicle 3 and/or the worker terminal 2 is out of a parking site where the vehicle should be stored, the 3D map generating unit 40 may map the received vehicle location to the nearest parking site on the 3D map from the vehicle location received from the vehicle 3 and/or the worker terminal 2. In such case, when another vehicle is already located at the nearest parking site, the 3D map generating unit 40 may notify it to the management server 10. The management server 10 may identify the corresponding vehicle using a plurality of cameras located at the storage for vehicles to be shipped, and find the actual location of the corresponding vehicle. The management server 10 may provide the found actual location to the 3D map generating unit 40, and the 3D map generating unit 40 may map the vehicle location to a parking site corresponding to the actual location among the plurality of parking sites.

The management server 10 may transmit to the worker terminal 2 that the indicated storage location and the current vehicle location do not match. Upon receiving the mismatch information, the worker may retransmit the vehicle location using the worker terminal 2.

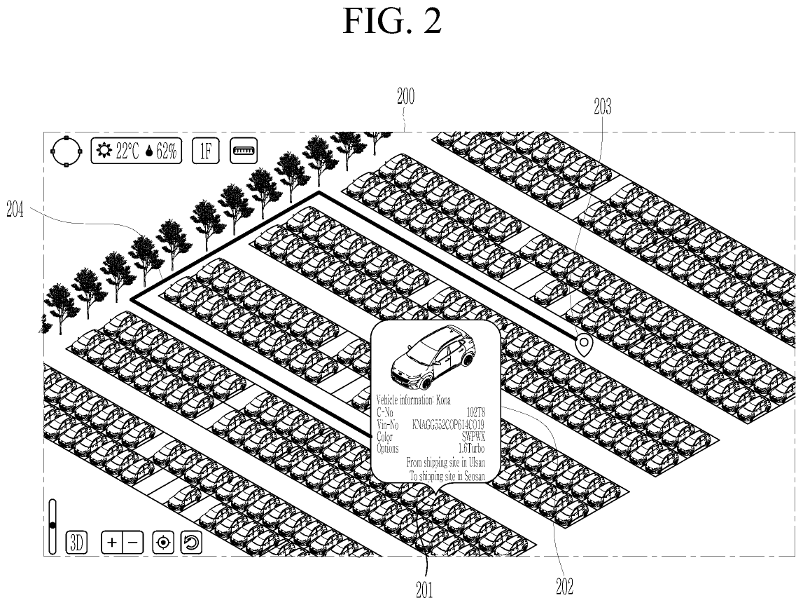

FIG. 2 is a drawing in which vehicles are displayed on a 3D map implemented according to an example embodiment of the present disclosure.

As shown in FIG. 2, information on a vehicle 201 moved by a worker may be displayed on a 3D map 200 along with the location of the corresponding vehicle 201. On an information window 202, vehicle information may be displayed.

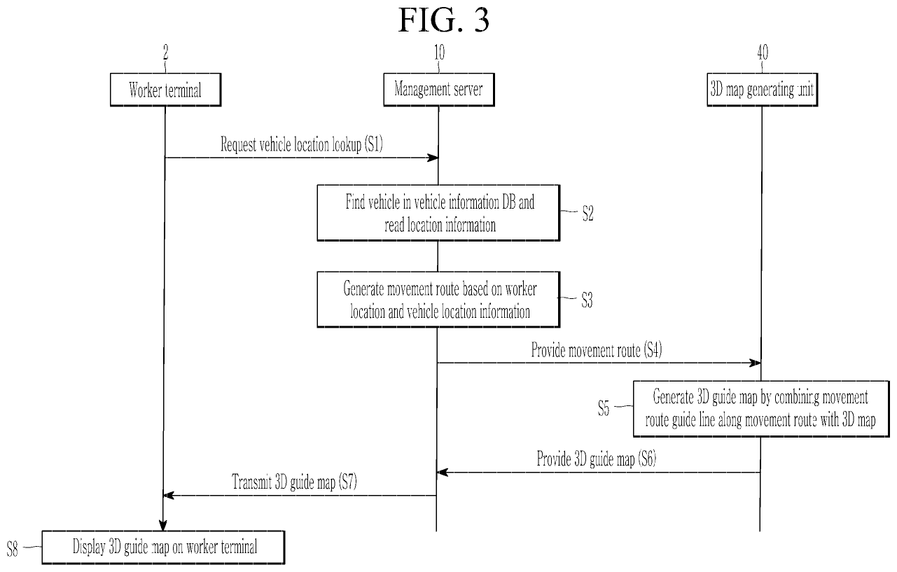

FIG. 3 is a flow chart illustrating a movement route display method according to an example embodiment of the present disclosure.

When a worker is located at a location 203 in FIG. 2 and needs to find and move the vehicle 201, the worker may request a location lookup from the management server 10 by inputting the management number of the vehicle to be moved through the worker terminal 2 (operation S1). The worker terminal 2 may transmit the GPS information of the worker terminal 2 to the management server 10 along with the location lookup request.

The management server 10 may receive the management number and the location lookup request from the worker terminal 2, and find the vehicle corresponding to the management number, in the vehicle information DB 20, and read the location information of the corresponding vehicle from the vehicle information DB 20 (operation S2).

The management server 10 may generate a movement route on the basis of the worker location based on the GPS information received from the worker terminal 2 and the location information of the corresponding vehicle (operation S3). The movement route may be a route that takes the shortest time to move from the worker location to the location of the vehicle. Alternatively, the movement route may be the route with the shortest distance from the worker location to the location of the vehicle.

The management server 10 may provide the generated movement route to the 3D map generating unit 40 (operation S4).

The 3D map generating unit 40 may generate a 3D guide map by combining a movement route guide line 204 along the movement route acquired from the management server 10 with the 3D map (operation S5). The 3D map generating unit 40 may generate a 3D guide map by combining the worker location 203, the location of the vehicle 201 required to be moved, and the information window 202 on the vehicle required to be moved with the 3D map.

The 3D map generating unit 40 may provide the 3D guide map to the management server 10 (operation S6).

The management server 10 may transmit the 3D guide map to the worker terminal 2 (operation S7).

The worker terminal 2 may display the received 3D guide map on the display of the worker terminal 2 (operation S8).

A system according to an embodiment of the present disclosure can easily find the locations of vehicles at the storage for vehicles to be shipped, thereby reducing the work time when finding a desired vehicle. A system according to an embodiment of the present disclosure may be applied to manage movement and locations of various items that are located for a while at a specific place, for example, to manage vehicles to be shipped, vehicles to be exported, parking lots, etc. A system according to an embodiment of the present disclosure can reduce the time and effort required for workers, users, or the like to find vehicles, items, or the like.

When a system according to an embodiment of the present disclosure is applied to a parking lot, the management server may receive information on whether there is any vehicle, from vehicle presence/absence sensors provided at parking sites, and accurately display the information in the form of a 3D map. A parking lot user may search for the location of their vehicle on the 3D map through a user terminal, or may search for the location of the vehicle through a terminal provided in the parking lot, for example, at a kiosk type terminal.

While present disclosure has been described in connection with what is presently considered to be practical example embodiments, it can be understood that the present disclosure is not necessarily limited to the disclosed example embodiments. On the contrary, the present disclosure can cover various modifications and equivalent arrangements included within the spirit and scopes of the appended claims.

What is claimed is:

1. A shipping mobility management system comprising:
a mobile-object information database storing moving object information and three-dimensional (3D) modeling of each moving object of a set of moving objects;
a 3D drawing database storing a first 3D map, wherein the first 3D map includes a 3D representation of a location map representing a place where the set of moving objects are located;
a management server configured to find a selected moving object being matched with moving object information received from an outside terminal in the mobile-object information database, and to record in the mobile-object information database, a moving object location received from the outside terminal in association with the selected moving object; and
a 3D map generating unit configured to generate a second 3D map by combining the 3D modeling of the selected moving object with the first 3D map.

2. The system of claim 1, wherein, in response to an error occurring between a selected parking site where the selected moving object should be stored among a plurality of parking sites and the moving object location received from the outside terminal, the 3D map generating unit is configured to map the moving object location to a nearest alternative parking site among the plurality of parking sites.

3. The system of claim 2, wherein, in response to another moving object different from the selected moving object being already located at the nearest alternative parking site, the 3D map generating unit is configured to notify the management server that the nearest alternative parking site is taken, and the management server is configured to identify the selected moving object using cameras, find an actual location of the selected moving object, and provide the actual location of the selected moving object to the 3D map generating unit.

4. The system of claim 1, wherein the outside terminal includes one of or both of the selected moving object and a worker terminal of a worker who moves the selected moving object.

5. A shipping mobility management method comprising:
receiving, at a management server, a management number of a moving object required to be moved and a location lookup request, from a worker terminal;
reading, by the management server, location information on the moving object corresponding to the management number from a vehicle information database;
generating, by the management server, a movement route based on a worker location using global positioning system (GPS) information received from the worker terminal and based on the location information on the moving object;
generating a 3D guide map by combining a movement route guide line along the movement route generated by the management server with a 3D map; and
transmitting the 3D guide map from the management server to the worker terminal.

6. The method of claim 5, further comprising generating the 3D guide map by combining the worker location and the location information of the moving object to be moved with the 3D map.

7. A vehicle storage management method comprising:
receiving a first vehicle information and a first vehicle location;
matching the first vehicle information with a first vehicle using a first database, wherein the first database includes the first vehicle information among many vehicle information sets corresponding to many vehicles respectively;
assigning the first vehicle to a first parking site corresponding to a nearest parking site among a set of parking sites for a storage parking lot based on the first vehicle location; and
storing the first parking site being associated with the first vehicle in a second database.

8. The method of claim 7, further comprising:
obtaining a worker terminal location using a first global positioning system (GPS) location from a GPS of a worker terminal; and
transmitting the worker terminal location as the first vehicle location from the worker terminal to a management server.

9. The method of claim 7, further comprising:
obtaining the first vehicle location using a first global positioning system (GPS) location from a GPS of the first vehicle; and
transmitting the first vehicle location from the first vehicle to a management server.

10. The method of claim 9, wherein the transmitting of the first vehicle location is performed in response to a transmission system of the first vehicle changing from a non-park status to a park status.

11. The method of claim 7, further comprising:
generating a first three-dimensional (3D) representation of the first vehicle;
generating a first 3D map including a first 3D representation of the first vehicle placed at the first parking site; and
transmitting the first 3D map to a worker terminal in a first configuration adapted to be displayed by the worker terminal.

12. The method of claim 11, further comprising:
generating a first worker route from a first worker terminal location of the worker terminal to the first parking site based on the first 3D map;
generating a first worker route visual representation for the first worker route adapted to overlay on the first 3D map;
generating a second 3D map including the first 3D map combined with the first worker route visual representation; and
transmitting the second 3D map to the worker terminal in a second configuration adapted to be displayed by the worker terminal.

13. The method of claim 12, in response to a notification that a second vehicle different than the first vehicle is actually at the first parking site, the method further comprises:
searching for the first vehicle in the storage parking lot using cameras at the storage parking lot; and
identifying an actual location of the first vehicle in the storage parking lot based on processing images from the cameras.

14. The method of claim 13, further comprising:
generating a second worker route from a second worker terminal location of the worker terminal to the actual location of the first vehicle based on the first 3D map;
generating a second worker route visual representation for the second worker route adapted to overlay on the first 3D map;
generating a third 3D map including the first 3D map combined with the second worker route visual representation; and
transmitting the third 3D map to the worker terminal in a third configuration adapted to be displayed by the worker terminal.

15. The method of claim 11, wherein the first 3D map is a storage parking lot 3D representation of the storage parking lot.

16. The method of claim 7, wherein the first database and the second database are at a same management server.

17. The method of claim 7, wherein the first database is a vehicle information database corresponding to a manufactured vehicle database of a vehicle manufacturing facility.
